(19) United States
(12) Patent Application Publication
(10) Pub. No.: US 2008/0259002 A1
(43) Pub. Date: Oct. 23, 2008

(54) PLASMA DISPLAY APPARATUS

(75) Inventors: Jeong Hyun HAHM, Gumi-si (KR); Seong Nam RYU, Gumi-si (KR); Woo Tae KIM, Gumi-si (KR); Young Gwang KANG, Gumi-si (KR); Jin Yeop KIM, Gumi-si (KR); Hee Kwon KIM, Gumi-si (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 12/104,510

(22) Filed: Apr. 17, 2008

(30) Foreign Application Priority Data
Apr. 19, 2007 (KR) 10-2007-0038488
Dec. 28, 2007 (KR) 10-2007-0140181

(51) Int. Cl. G09G 3/28

(52) U.S. Cl. 345/67

(57) ABSTRACT

The present invention relates to a plasma display apparatus. The plasma display apparatus includes an upper substrate; first and second electrodes formed on the upper substrate; a lower substrate disposed opposite to the upper substrate; and a third electrode formed on the lower substrate. At least one of the first and second electrodes is formed as one layer, and includes first and second electrode lines formed in a direction intersecting the third electrode and a connecting electrode that connects the first and second electrode lines. The distance between the first and second electrode lines has a value of 2 or more in one discharge cell. Accordingly, manufacturing cost of a plasma display panel can be saved by removing a transparent electrode made from ITO. Further, a discharge firing voltage can be reduced and the luminance of a display image can also be improved by variably adjusting the distance between two electrode lines constituting a scan or sustain electrode.

This Nonprovisional application claims priority under 35 U.S.C. § 119(a) on Patent Application No. 10-2007-0038488 filed in Korea on Apr. 19, 2008, and Patent Application No. 10-2007-0140181 filed in Korea on Dec. 28, 2008, the entire contents of which are hereby incorporated by reference.

### BACKGROUND OF THE INVENTION

1. Field of the Invention

The present invention relates to a plasma display apparatus and, more particularly, to an electrode structure of a panel provided to a plasma display apparatus.

2. Discussion of Related Art

In general, a plasma display panel includes an upper substrate, a lower substrate and a barrier rib defining one unit cell between the upper and lower substrates. Each cell is filled with an inert gas containing a major discharge gas and a small amount of xenon, such as neon (Ne), helium (He) or a mixed gas of neon and helium (Ne+He). When discharge is generated by a high-frequency voltage, the inert gas generates vacuum ultraviolet rays, and a phosphor material formed between barrier ribs is excited with the vacuum ultraviolet rays, thereby displaying images. Since such a plasma display panel is thin and light, it has come into the spotlight as a next-generation display apparatus.

In the case of a general plasma display panel, scan and sustain electrodes are formed on an upper substrate, and each of the scan and sustain electrodes has a stack structure of transparent and bus electrodes formed from indium-tin-oxide (ITO) in order to secure the aperture ratio of the panel.

Recently, it has been required to manufacture a plasma display panel capable of saving manufacturing cost and improving visible and driving characteristics suitable for user's watching.

### SUMMARY OF THE INVENTION

An object of the present invention is to provide a plasma display apparatus provided with a plasma display panel capable of saving manufacturing cost of the panel and improving the luminance of a display image by removing a transparent electrode formed from ITO.

A plasma display apparatus according to the present invention includes an upper substrate; first and second electrodes formed on the upper substrate; a lower substrate disposed opposite to the upper substrate; and a third electrode formed on the lower substrate. At least one of the first and second electrodes is formed as one layer, and comprises first and second electrode lines formed in a direction intersecting the third electrode and a connecting electrode that connects the first and second electrode lines. The distance between the first and second electrode lines has a value of 2 or more in one discharge cell.

### BRIEF DESCRIPTION OF THE DRAWINGS

FIG. 1 is a perspective view illustrating an embodiment of the structure of a plasma display panel according to the present invention;

FIG. 2 is a view illustrating an embodiment of the electrode arrangements of the plasma display panel;

FIG. 3 is a timing diagram illustrating an embodiment of a method of time-dividing and driving the plasma display panel by dividing one frame into a plurality of subfields;

FIG. 4 is a timing diagram illustrating an embodiment of driving signals for driving the plasma display panel;

FIG. 5 is a sectional view briefly illustrating an electrode structure formed on an upper substrate of the plasma display panel;

FIGS. 6 and 7 are sectional views illustrating embodiments of the electrode structure formed on the upper substrate of the plasma display panel according to the present invention;

FIGS. 9 to 11 are sectional views illustrating embodiments of the electrode structure formed on the upper substrate of the plasma display panel according to the present invention;

FIGS. 8 and 12 are graphs illustrating discharge firing voltage measurement results of the plasma display panel according to the present invention;

FIGS. 13 and 14 are sectional views illustrating embodiments of the electrode structure formed on the upper substrate of the plasma display panel according to the present invention; and

FIGS. 15 to 18 are sectional views illustrating embodiments of the structure of the upper substrate of the plasma display panel according to the present invention.

### DETAILED DESCRIPTION OF THE INVENTION

A plasma display apparatus according to the present invention will now be described in detail in connection with specific embodiments with reference to the accompanying drawings.

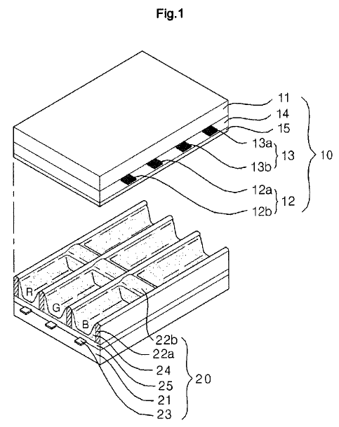

FIG. 1 is a perspective view illustrating an embodiment of the structure of a plasma display panel according to the present invention.

Referring to FIG. 1, the plasma display panel includes an upper panel 10 and a lower panel 20, which are joined together at a predetermined space.

The upper panel 10 includes a sustain electrode pair 12 and 13 formed on an upper substrate 11 while making a pair. The sustain electrode pair 12 and 13 are divided into a scan electrode 12 and a sustain electrode 13 depending on their functions. The sustain electrode pair 12 and 13 are covered by an upper dielectric layer restricting a discharge current and insulating the electrode pair from each other, and a protection layer 15 is formed on the upper dielectric layer 14 to protect the upper dielectric layer 14 from sputtering of charged particles generated at the time of gas discharge and also increase emission efficiency of secondary electrons.

Discharge spaces between the upper substrate 11, a lower substrate 21 and barrier ribs 22 are injected with a discharge gas. Preferably, the discharge gas includes xenon (Xe) of 10% or more. In the event that the discharge gas includes the xenon (Xe) with the mixture ratio described above, discharge/luminous efficiency of the plasma display panel can be enhanced.

The lower panel 20 includes a plurality of discharge spaces, i.e., barrier ribs 22 partitioning discharge cells, formed on the lower substrate 21. Address electrodes 23 are disposed in a direction intersecting with the sustain electrode pair 12 and 13, and a phosphor layer 24 generating visible rays emitted by ultraviolet rays generated at the time of gas discharge is coated on surfaces of a lower dielectric layer 25 and the barrier ribs 22.

At this time, each of the barrier ribs 22 has a longitudinal barrier rib 22a formed in a direction parallel with the address electrodes 23 and a traverse barrier rib 22b formed in a direction traversing the address electrodes 23. The barrier rib 22 functions to partition discharge cells physically and prevent ultraviolet rays, which are generated by discharge, and a visible ray from leaking to neighboring discharge cells.

In the plasma display panel according to the present invention, the sustain electrode pair 12 and 13 include only opaque metal electrodes. That is, the sustain electrode pair 12 and 13 are not formed using ITO, which is a conventional transparent electrode material, but formed using silver (Ag), copper (Cu) or chrome (Cr), which is a conventional bus electrode material. In other words, each of the sustain electrode pair 12 and 13 of the plasma display panel according to the present invention does not include a conventional ITO electrode but includes a bus electrode as one layer.

For example, it is preferred that each of the sustain electrode pair 12 and 13 according to the embodiment of the present invention be formed of silver (Ag). Preferably, the silver (Ag) has a photosensitive property. In addition, each of the sustain electrode pair 12 and 13 according to the embodiment of the present invention may have a darker color and lower transmittance of light than the upper or lower dielectric layer 14 or 25.

The discharge cell may have a symmetric structure in which the pitches of the phosphor layers 24 of red (R), green (G) and blue (B) are the same as one another, or a non-symmetric structure in which the pitches of the phosphor layers 24 of red (R), green (G) and blue (B) are different from one another. The discharge cell may have a non-symmetric structure in which the phosphor layers 24 of red (R), green (G) and blue (B) have the order of the pitch of a red (R) cell<the pitch of a green (G) cell<the pitch of a blue (B) cell.

As shown in FIG. 1, each of the sustain electrode pair 12 and 13 in one discharge cell may include a plurality of electrode lines. That is, the first sustain electrode 12 may include two electrode lines 12a and 12b, and the sustain electrode 13 may include two electrode lines 13a and 13b. The second sustain electrode 13 is disposed to be symmetric with the first sustain electrode 12 about the center of the discharge cell.

Preferably, the first and second sustain electrodes 12 and 13 are respectively a scan electrode and a sustain electrode, in consideration of the aperture ratio and discharge diffusion efficiency caused by use of the opaque sustain electrode pair 12 and 13. That is, an electrode line having a narrow width is used in consideration of the aperture ratio, and a plurality of electrode lines are used in consideration of the discharge diffusion efficiency. At this time, the number of electrode lines may be determined in consideration of both the aperture ratio and discharge diffusion efficiency.

The structure shown in FIG. 1 is only an embodiment of the structure of the plasma display panel according to the present invention. Therefore, the present invention is not limited to the structure of the plasma display panel shown in FIG. 1. For example, black matrices (BM) may be formed on the upper substrate 11. The black matrix has a light-shielding function of absorbing external light generated outside the upper substrate 11 and decreasing reflection of the light and a function of improving the purity and contrast of the upper substrate 11. The black matrices may have both separate and integrated BM structures.

In addition, the structure of the barrier ribs shown in FIG. 1 is of a closed type in which the discharge cell has a closed structure formed with the longitudinal barrier rib 22a and the traverse barrier rib 22b. However, the structure of the barrier ribs may be of a stripe type in which the discharge cell includes only longitudinal barrier walls, or of a fish-bone type in which protrusions are formed at a predetermined distance on a longitudinal barrier rib.

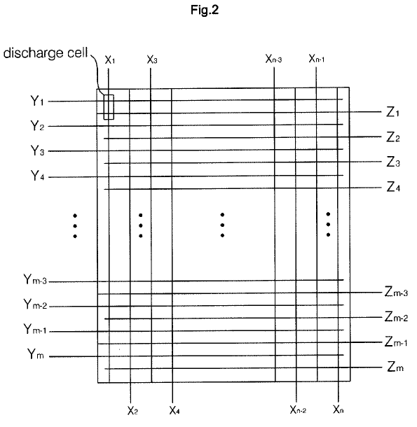

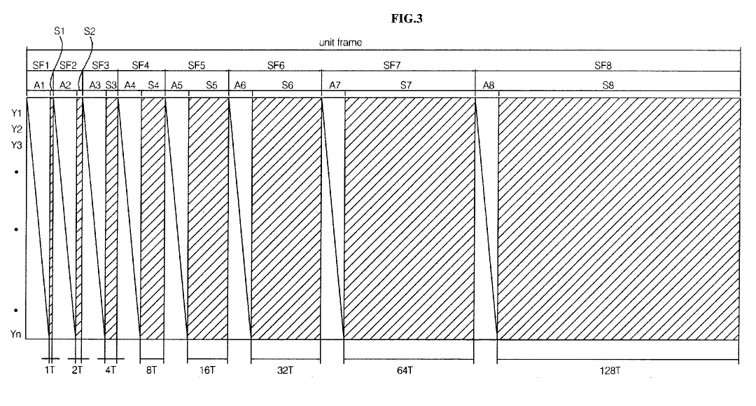

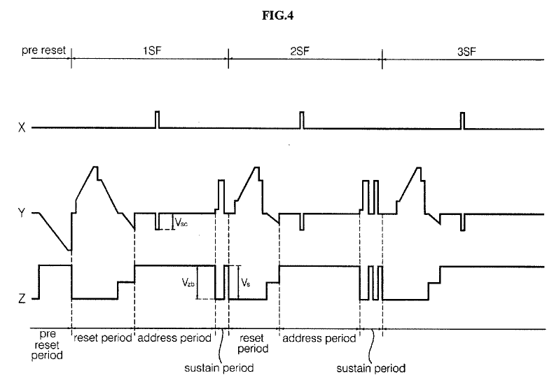

FIG. 2 is a view illustrating an embodiment of electrode arrangements of the plasma display panel. It is preferred that a plurality of discharge cells constituting the plasma display panel be arranged in a matrix form as illustrated in FIG. 2. The plurality of discharge cells are disposed at the intersections of scan electrode lines Y1 to Ym, sustain electrodes lines Z1 to Zm, and address electrodes lines X1 to Xn, respectively. The scan electrode lines Y1 to Ym may be driven sequentially or at the same time. The sustain electrode lines Z1 to Zm may be driven at the same time. The address electrode lines X1 to Xn may be driven with them being divided into even-numbered lines and odd-numbered lines, or driven sequentially.

The electrode arrangements shown in FIG. 2 are only an embodiment of electrode arrangements of the plasma display panel according to the present invention. Therefore, the present invention is not limited to the electrode arrangements and the driving method of the plasma display panel shown in FIG. 2. For example, the present invention may also be applied to a dual scan method of driving two of the scan electrode lines Y1 to Ym at the same time. Alternatively, the address electrode lines X1 to Xn may be driven with them being divided into upper and lower parts on the basis of the center of the plasma display panel.

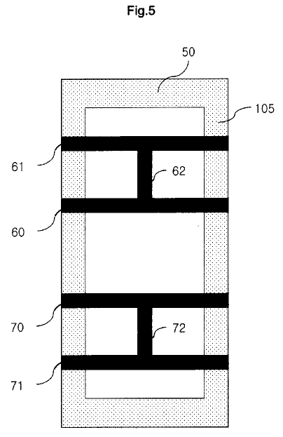

FIG. 3 is a timing diagram illustrating an embodiment of a method of time-dividing and driving the plasma display panel by dividing one frame into a plurality of subfields. A unit frame may be divided into a predetermined number (for example, eight subfields SF1, . . . , SF8) in order to realize a time-divided gray level display. Each of the subfields SF1, . . . , SF8 is divided into a reset period (not shown), address periods A1, . . . , A8, and sustain periods S1, . . . , S8.

In accordance with an embodiment of the present invention, the reset period may be omitted in at least one of the plurality of subfields. For example, the reset period may exist only in the first subfield, or exist only in a subfield approximately between the first subfield and the entire subfields.

In each of the address periods A1, . . . , A8, a display data signal is applied to the address electrode X, and scan signals corresponding to the scan electrodes Y are sequentially applied to the address electrode X.

In each of the sustain periods S1, . . . , S8, a sustain pulse is alternately applied to the scan electrodes Y and the sustain electrodes Z. Accordingly, sustain discharge is generated in discharge cells on which wall charges are formed in the address periods A1, . . . , A8.

The luminance of the plasma display panel is proportional to the number of sustain discharge pulses within the sustain periods S1, . . . , S8, which is occupied in a unit frame. In the event that one frame to form 1 image is represented by eight subfields and 256 gray levels, different numbers of sustain pulses may be sequentially allocated to the respective subfields at a ratio of 1, 2, 4, 8, 16, 32, 64, and 128. For example, in order to obtain the luminance of 133 gray levels, sustain discharge can be generated by addressing the cells during the subfield1 period, the subfield3 period, and the subfield8 period.

The number of sustain discharges allocated to each subfield may be varied depending on the weight of a subfield according to an Automatic Power Control (APC) step. In other words, although an example in which one frame is divided into eight subfields has been described with reference to FIG. 3, the present invention is not limited to the above example, but the number of subfields to form one frame may be changed in various ways depending on design specifications. For example, the plasma display panel may be driven by dividing one frame into eight or more subfields, such as 12 or 16 subfields.

Further, the number of sustain discharges allocated to each subfield may be changed in various ways in consideration of gamma characteristics or panel characteristics. For example, the degree of gray levels allocated to the subfield4 may be lowered from 8 to 6, and the degree of gray levels allocated to the subfield6 may be raised from 32 to 34.

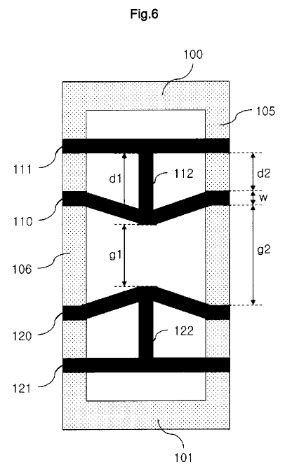

FIG. 4 is a timing diagram illustrating an embodiment of driving signals for driving the plasma display panel with respect to the one divided subfield.

Each subfield includes a pre-reset period where positive wall charges are formed on the scan electrodes Y and negative wall charges are formed on the sustain electrodes Z, a reset period where discharge cells of the entire screen are reset using wall charge distributions formed in the pre-reset period, an address period where discharge cells are selected, and a sustain period where the discharge of selected discharge cells is sustained.

The reset period includes a set-up period and a set-down period. In the set-up period, a ramp-up waveform is applied to the entire scan electrodes at the same time, so that a minute discharge occurs in the entire discharge cells and wall charges are generated accordingly. In the set-down period, a ramp-down waveform, which falls from a positive voltage lower than a peak voltage of the ramp-up waveform, is applied to the entire scan electrodes Y at the same time, so erase discharge is generated in the entire discharge cells. Accordingly, unnecessary charges are erased from the wall charges generated by the set-up discharge and spatial charges.

In the address period, a scan signal having a scan voltage Vsc of a negative polarity is sequentially applied to the scan electrodes Y and at the same time, a data signal of a positive polarity is applied to the address electrodes X. Address discharge is generated by a voltage difference between the scan signal and the data signal and a wall voltage generated during the reset period, so the cells are selected. Meanwhile, in order to enhance the efficiency of the address discharge, a sustain bias voltage Vzb is applied to the sustain electrode during the address period.

During the address period, the plurality of scan electrodes Y may be divided into two or more groups and sequentially supplied with the scan signal on a group basis. Each of the divided groups may be divided into two or more subgroups and sequentially supplied with the scan signal on a subgroup basis. For example, the plurality of scan electrodes Y may be divided into a first group and a second group. For example, the scan signal may be sequentially supplied to scan electrodes belong to the first group, and then sequentially supplied to scan electrodes belong to the second group.

In an embodiment of the present invention, the plurality of scan electrodes Y may be divided into a first group placed at the even number and a second group placed at the odd number depending upon a position formed on the panel. In another embodiment, the plurality of scan electrodes Y may be divided into a first group disposed on an upper side and a second group disposed on a lower side on the basis of the center of the panel.

The scan electrodes belonging to the first group divided according to the above method may be divided into a first subgroup placed at the even number and a second subgroup placed at the odd number, or a first subgroup disposed on an upper side and a second subgroup disposed on a lower side on the basis of the center of the first group.

In the sustain period, a sustain pulse having a sustain voltage Vs is alternately applied to the scan electrode and the sustain electrode, so sustain discharge is generated between the scan electrode and the sustain electrode in a surface discharge form.

A width of a first sustain signal or the last sustain signal of a plurality of sustain signals, which are alternately applied to the scan electrode and the sustain electrode during the sustain period, may be greater than that of the remaining sustain pulses.

After the sustain discharge is generated, an erase period in which wall charges remaining in the scan electrodes or the sustain electrodes of an on-cell selected in the address period are erased by generating weak discharge may be further included posterior to the sustain period.

The erase period may be included in all the plurality of subfields or some of the plurality of subfields. In this erase period, an erase signal for the weak discharge may be applied to electrodes to which the last sustain pulse was not applied in the sustain period.

The erase signal may include a ramp type signal that gradually rises, a low-voltage wide, a high-voltage narrow pulse, an exponential signal, a half-sinusoidal pulse or the like.

In addition, in order to generate the weak discharge, a plurality of pulses may be sequentially applied to the scan electrodes or the sustain electrodes.

The driving waveforms shown in FIG. 4 illustrate embodiments of signals for driving the plasma display panel according to the present invention. However, it is to be noted that the present invention is not limited to the waveforms shown in FIG. 4. For instance, the pre-reset period may be omitted, the polarity and voltage level of the driving signals shown in FIG. 4 may be changed, if appropriate, and the erase signal for erasing wall charges may be applied to the sustain electrode after the sustain discharge is completed. Alternatively, a single sustain driving method in which the sustain signal is applied to either the scan electrode Y or the sustain electrode Z, thus generating sustain discharge is also possible.

FIG. 5 is a sectional view briefly illustrating an electrode structure formed on an upper substrate of the plasma display panel, in which only the structure of a sustain electrode pair 12 and 13 formed in one discharge cell is briefly illustrated in the plasma display panel shown in FIG. 1.

Referring to FIG. 5, sustain electrodes according to an embodiment of the present invention, i.e., a scan electrode and a sustain electrode, are formed to be symmetric with each other about the center of the discharge cell while making a pair. Each of the sustain electrodes may include at least two electrode lines 60 and 61 or 70 and 71 transversing the discharge cell.

Each of the sustain electrodes may further include a connecting electrode 62 or 72 connecting the two electrode lines 60 and 61 or 70 and 71.

The electrode lines 60, 61, 70 and 71 transverse the discharge cell and may extend in a direction parallel with a transverse barrier rib 50 of barrier ribs defining the discharge cell.

The connecting electrodes 62 and 72 allow discharge started at a central portion of the discharge cell to be easily diffused up to the electrode lines 61 and 71 disposed distant from the center of the discharge cell, respectively.

As described above, discharge efficiency is enhanced using the plurality of electrode lines 60, 61, 70 and 71 and the connecting electrodes 62 and 72, so that luminous efficiency of the plasma display panel can be entirely enhanced. Accordingly, an ITO transparent electrode can be removed without reducing luminance of the plasma display panel.

In the event that each of the sustain electrodes includes two electrode lines 60 and 61 or 70 and 71 as shown in FIG. 5, it is preferred that the distance between the two electrode lines 60 and 61 or 70 and 71 be formed narrowly in order to prevent a reduction in the luminance of a display image. As the distance between the two electrode lines 60 and 61 or 70 and 71 becomes narrow, the distance between the two sustain electrodes becomes broad, and therefore a discharge firing voltage can be increased.

Thus, in the case of the plasma display apparatus according to the present invention, the distance between the two electrode lines 60 and 61 or 70 and 71 constituting the sustain electrode is variably adjusted, so that the luminance of a display images is not reduced, and a discharge firing voltage is decreased.

FIG. 6 is a sectional view illustrating an embodiment of the electrode structure formed on the upper substrate of the plasma display panel according to the present invention.

Referring to FIG. 6, the distance between a first electrode lines 110 or 120 and a second electrode line 111 or 121, which constitute a sustain electrode, may have a value of 2 or more.

That is, the distance between the first and second electrode lines 110 and 111 constituting a scan electrode may have a value of 2 or more, and the distance between the first and second electrode lines 120 and 121 constituting a sustain electrode may have a value of 2 or more.

Hereinafter, the embodiment of the electrode structure formed on the upper substrate of the plasma display panel according to the present invention will be described with respect to the first and second electrode lines 110 and 111 constituting the scan electrode.

Referring to FIG. 6, the second electrode line 111 disposed distant from the center of the discharge cell may be formed in parallel with a transverse barrier rib 100 of barrier ribs defining the discharge cell, and the first electrode line 110 disposed close to the center of the discharge cell may be formed to have a slope of 2 or more.

As shown in FIG. 6, the distance between the first and second electrode lines 110 and 111 may be gradually decreased from the left/right center to left/right edge of the discharge cell.

That is, the distance between the first and second electrode lines 110 and 111 may have a maximum value d1 at a central portion overlapping with the center line between adjacent two longitudinal barrier ribs 105 and 106, and may have a minimum value d2 at an edge portion overlapping with the longitudinal barrier rib 105 or 106.

As shown in FIG. 6, the distance between the first and second electrode lines 110 and 111 is the greatest at the central portion of the discharge cell, so that the distance between the scan and sustain electrodes is minimized at the center of the discharge cell, where discharge is generally started, and therefore a discharge firing voltage can be lowered. Simultaneously, the distance between the first and second electrode lines 110 and 111 is decreased at the edge portion of the discharge cell, and therefore the luminance of a display image can be enhanced.

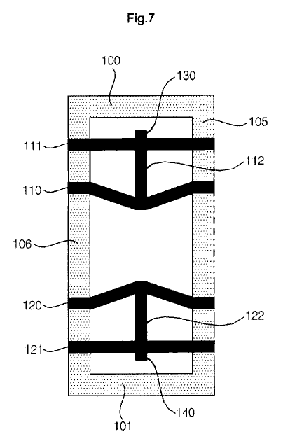

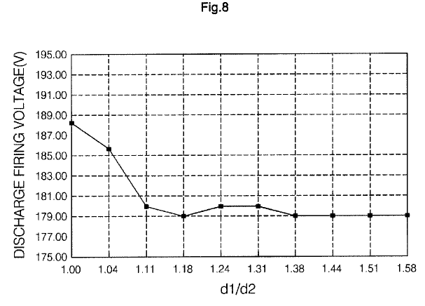

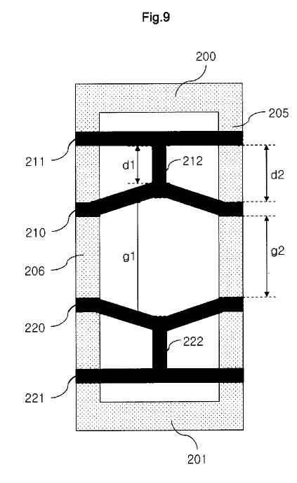

Referring to FIG. 7, the plasma display apparatus according to the present invention may further include protruding electrodes 130 and 140 respectively protruded from the second electrode lines 111 and 121 disposed distant from the center of the discharge cell to directions of the transverse barrier ribs 100 and 101 adjacent to the second electrode lines 111 and 121.

Through the protruding electrodes 130 and 140, discharge is diffused up to upper/lower edge regions of the discharge cell to be uniformly generated at the entire region of the discharge cell. Accordingly, the quality of a display image can be improved.

The following Table 1 lists the measurement results of a discharge firing voltage and luminance of a display image depending on the change in the distance d1 between the first and second electrode lines 110 and 111 at the central portion of the discharge cell and the distance d2 between the first and second electrode lines 110 and 111 at the edge portion of the discharge cell.

TABLE 1

| | | | Discharge | |
|---|---|---|---|---|
| | | | firing | Luminance |
| d1 (μm) | d2 (μm) | d1/d2 | voltage | (cd/m²) |
| 45 | 45 | 1.00 | 188 V | 485 |
| 47 | 45 | 1.04 | 186 V | 485 |
| 50 | 45 | 1.11 | 180 V | 484 |
| 53 | 45 | 1.18 | 179 V | 480 |
| 56 | 45 | 1.24 | 180 V | 479 |
| 59 | 45 | 1.31 | 180 V | 475 |
| 62 | 45 | 1.38 | 179 V | 474 |
| 65 | 45 | 1.44 | 179 V | 439 |
| 68 | 45 | 1.51 | 179 V | 428 |
| 71 | 45 | 1.58 | 179 V | 402 |

FIG. 8 is a graph illustrating a relation between d1/d2 and the discharge firing voltage in accordance with the measurement results of Table 1.

Referring to Table 1 and FIG. 8, as d1/d2 increases, the distance between the scan and sustain electrodes, i.e., the distance g1 between the two first electrode lines 110 and 120 may be decreased at the central portion of the discharge cell, where discharge is started, and therefore a discharge firing voltage may be lowered.

For example, in the event that d1/d2 increases up to 1.11 or more, the discharge firing voltage may be rapidly lowered down to 180V or less as compared with when d1/d2 is below 1.11.

On the other hand, as shown in Table 1, as d1/d2 increases, the aperture ratio of the panel decreases at the central portion of the discharge cell, and therefore the luminance of a display image may be reduced. For example, in the event that d1/d2 exceeds 1.38, the luminance of a display image may be rapidly reduced down to 450 cd/m² or less.

Preferably, the ratio d1/d2 of maximum to minimum values of the distance between the first and second electrode lines 110 and 111 is 1.11 to 1.38 so that the discharge firing voltage is maintained to be 180V or less, and the luminance of a display image is stably maintained to be 450 cd/m² or more.

Considering the longitudinal width of the discharge cell, when the ratio d1/d2 of the maximum to minimum values of the distance between the first and second electrode lines 110 and 111 is 1.11 to 1.38, the distance g1 between the scan and sustain electrodes at the central portion of the discharge cell may be 1.05 to 1.4 of the distance g2 between the scan and sustain electrodes at the edge portion of the discharge cell.

That is, when the ratio g1/g2 of maximum to minimum values of the distance between the scan and sustain electrodes is 1.05 to 1.4, the discharge firing voltage can be lowered, and a reduction of the luminance of a display image can also be prevented.

In order to secure the aperture ratio of the panel and reduce the discharge firing voltage as described above, it is preferred that the distance g1 between the scan and sustain electrodes is 1.9 to 3 of the line width of the electrode line.

Although the section of each of the first electrode line 110 and 120 has a square shape in FIGS. 6 and 7, the section of each of the first electrode line 110 and 120 may have a curved shape. In this case, the distance between the first and second electrode lines 110 and 111 may also have the greatest value at the central portion of the discharge cell.

FIG. 9 is a sectional view illustrating an embodiment of the electrode structure formed on the upper substrate of the plasma display panel according to the present invention.

Referring to FIG. 9, the distance between first and second electrode lines 210 and 211 may be increased from the center to a left/right edge of a discharge cell.

For example, the distance between the first and second electrode lines 210 and 211 may have a maximum value d1 at a central portion overlapping with the center line between adjacent two longitudinal barrier ribs 205 and 206, and may have a minimum value d2 at an edge portion overlapping with the longitudinal barrier rib 205 or 206.

As shown in FIG. 9, the distance between the first and second electrode lines 210 and 211 is the smallest at the central portion of the discharge cell, so that the aperture ratio of the panel is enhanced at the center of the discharge cell, where discharge is generally started, and therefore the luminance of a display image can be enhanced. Further, the distance d2 between the first and second electrode lines 210 and 211 is increased at the edge portion of the discharge cell, so that discharge efficiency can be prevented from being largely reduced.

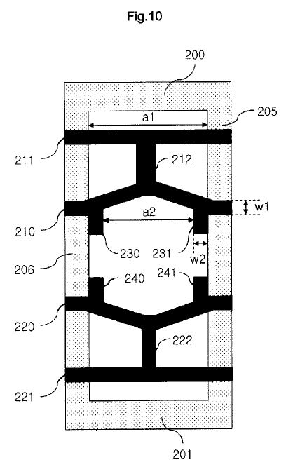

Referring to FIG. 10, the plasma display apparatus according to the present invention may further include protruding electrodes 230, 231, 240 and 241 respectively protruded from the first electrode lines 210 and 220 disposed close to the center of the discharge cell to central directions of the discharge cell.

Through the protruding electrodes 230, 231, 240 and 241, a discharge firing voltage is decreased, and discharge efficiency is enhanced, thereby improving a driving voltage margin. Further, the length of a current path is increased, thereby preventing a flickering delay generated due to the configuration of the first and second lines 210 and 211 or 220 and 221 constituting the sustain electrode.

As shown in FIG. 10, the number of protruding electrodes 230 and 231 protruded from the first electrode line 210 may be two.

In the event that the two protruding electrodes 230 and 231 are disposed at a central portion of the discharge cell, the luminance of a display image may be lowered. Therefore, in order to enhance discharge efficiency without reducing the luminance of a display image, it is preferred that the distance a1 between adjacent two longitudinal barrier ribs 205 and 206 is 1.7 to 3 of the distance a2 between the protruding electrodes 230 and 231.

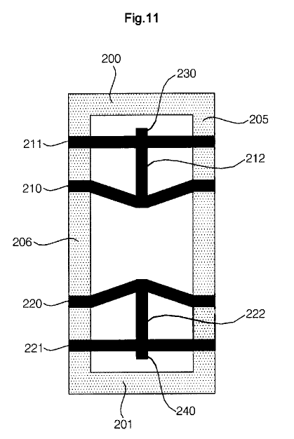

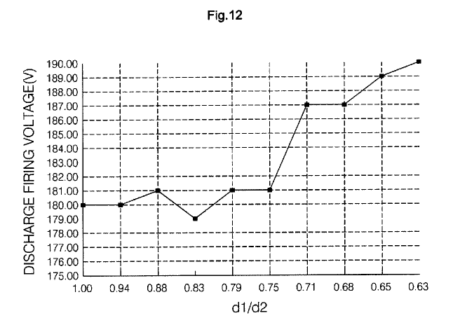

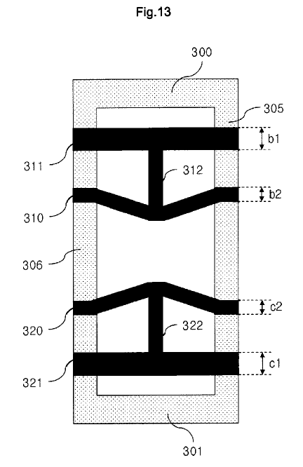

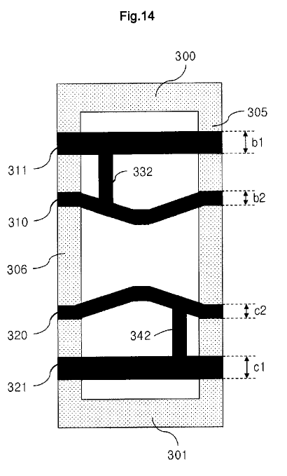

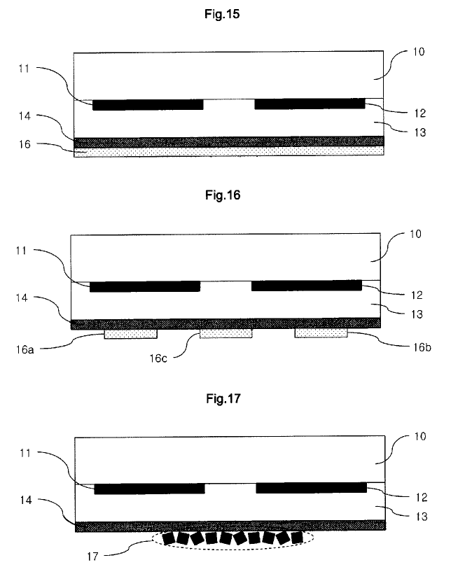

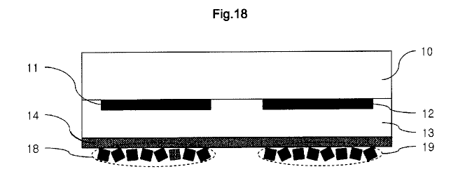

Referring to FIG. 11, the plasma display apparatus according to the present invention may further include protruding electrodes 230 and 240 respectively protruded from the second electrode lines 211 and 221 disposed distant from the center of the discharge cell to directions of the transverse barrier ribs 200 and 201 adjacent to the second electrode lines 211 and 221.

Through the protruding electrodes 230 and 240, discharge is diffused up to upper/lower edge regions of the discharge cell to be uniformly generated at the entire region of the discharge cell. Accordingly, the quality of a display image can be improved.

The following Table 2 lists the measurement results of a discharge firing voltage and luminance of a display image depending on the change in the distance d1 between the first and second electrode lines 210 and 211 at the central portion of the discharge cell and the distance d2 between the first and second electrode lines 210 and 211 at the edge portion of the discharge cell.

TABLE 2

| | | | Discharge | |
|---|---|---|---|---|
| | | | firing | Luminance |
| d1 (μm) | d2 (μm) | d1/d2 | voltage | (cd/m²) |
| 45 | 45 | 1.00 | 180 V | 402 |
| 45 | 48 | 0.94 | 180 V | 467 |
| 45 | 51 | 0.88 | 181 V | 469 |
| 45 | 54 | 0.83 | 179 V | 478 |
| 45 | 57 | 0.79 | 181 V | 481 |
| 45 | 60 | 0.75 | 181 V | 481 |
| 45 | 63 | 0.71 | 187 V | 482 |
| 45 | 66 | 0.68 | 187 V | 484 |
| 45 | 69 | 0.65 | 189 V | 485 |
| 45 | 72 | 0.63 | 190 V | 485 |

FIG. 12 is a graph illustrating a relation between d1/d2 and the discharge firing voltage in accordance with the measurement results of Table 2.

Referring to Table 2 and FIG. 12, as d1/d2 decreases, the distance between the scan and sustain electrodes, i.e., the distance g1 between the two first electrode lines 210 and 220 may be increased at the central portion of the discharge cell, where discharge is started, and therefore a discharge firing voltage may be increased.

For example, in the event that d1/d2 decreases down to below 0.75, the discharge firing voltage may be rapidly increased up to 187V or more as compared with when d1/d2 is 0.75 or more.

As shown in Table 2, as d1/d2 increases, the aperture ratio of the panel decreases at the central portion of the discharge cell, and therefore the luminance of a display image may be reduced. For example, in the event that d1/d2 exceeds 0.94, the luminance of a display image may be rapidly reduced down to 450 cd/m² or less.

Preferably, the ratio d1/d2 of maximum to minimum values of the distance between the first and second electrode lines 210 and 211 is 0.75 to 0.94 so that the luminance of a display image is enhanced, and the discharge firing voltage is not rapidly increased.

In order to secure the aperture ratio of the panel and reduce the discharge firing voltage as described above, it is preferred that the distance g1 between the scan and sustain electrodes be 1.9 to 3 of the line width of the electrode line.

Although in FIGS. 9 to 11,. In this case,. Although the section of each of the first electrode line 210 and 220 has a square shape in FIGS. 9 to 11, the section of each of the first electrode line 210 and 220 may have a curved shape. In this case, the distance between the first and second electrode lines 210 and 211 may also have the smallest value at the central portion of the discharge cell.

FIG. 13 is a sectional view illustrating an embodiment of the electrode structure formed on the upper substrate of the plasma display panel according to the present invention.

Referring to FIG. 13, the widths b1 and b2 of adjacent two electrode lines 311 and 310 may be different from each other.

In the event that the amounts of wall charges formed in the two electrode lines 310 and 311 are different, the amount of light generated at the time of sustain discharge may be changed depending on the positions of the two electrode lines 310 and 311, and therefore a spot pattern may be produced in a display image.

For example, since wall charges are formed by diffused discharge in the electrode line 311 disposed at an edge portion of the discharge cell, the electrode line 311 may have the amount of wall charges formed by address discharge less than the electrode line 310 adjacent to the center of the discharge cell. Thus, the width b1 of the electrode line 311 disposed at the edge portion of the discharge cell is greater than the width b2 of the electrode line 310 adjacent to the center of the discharge cell, so that the amount of wall charges formed in the two electrode lines 310 and 311 can be uniform.

As described above, the amount of wall charges formed in the two electrode lines 310 and 311 is uniform, so that discharge is uniformly generated at the entire region of the discharge cell, thereby preventing quality reduction generated in a display image.

The following Table 3 lists whether a spot pattern occurred and the measurement results of luminance depending on changes in widths b1 and b2 of the adjacent two electrode lines 311 and 310.

TABLE 3

| | | Spotty pattern | Luminance |
|---|---|---|---|
| b1 (μm) | b2 (μm) | occurred? | (cd/m²) |
| 28 | 40 | ◯ | 485 |
| 32 | 40 | ◯ | 485 |
| 36 | 40 | ◯ | 484 |
| 40 | 40 | ◯ | 480 |
| 44 | 40 | X | 479 |
| 48 | 40 | X | 479 |
| 52 | 40 | X | 475 |
| 56 | 40 | X | 474 |
| 60 | 40 | X | 471 |
| 64 | 40 | X | 468 |
| 68 | 40 | X | 467 |
| 72 | 40 | X | 465 |
| 76 | 40 | X | 461 |
| 80 | 40 | X | 459 |
| 84 | 40 | X | 431 |
| 88 | 40 | X | 410 |
| 92 | 40 | X | 390 |
| 96 | 40 | X | 375 |

Referring to Table 3, when the width b1 of the electrode line 311 disposed at the edge portion of the discharge cell is 44 μm or more, no spot pattern is produced in a display image. However, when the width b1 of the electrode line 311 disposed at the edge portion of the discharge cell is over 80 μm, the luminance of a display image is rapidly decreased down to 460 cd/m² or less.

Thus, when the width b1 of the electrode line 311 disposed at the edge portion of the discharge cell is 1.1 to 2 of the width b2 of the electrode line 310 adjacent to the center of the discharge cell, a reduction of quality of a display image can be prevented, and the luminance of a display image can also be improved.

Alternatively, the width b1 of the electrode line 311 disposed at the edge portion of the discharge cell may be 1.15 to 1.5 of the width b2 of the electrode line 310 adjacent to the center of the discharge cell so that the amount of wall charges is uniform by increasing the amount of wall charges formed in the electrode line 311 without largely reducing discharge diffusion efficiency.

Referring to FIG. 14, connecting electrodes 332 and 342 may be formed to be biased to the left and right from the center of the discharge cell, respectively. That is, each of the connecting electrodes 332 and 342 may be formed at a position that is not overlapped with an address electrode formed while passing through the center of the discharge cell on the lower substrate of the panel.

As shown in FIG. 14, the connecting electrodes are formed at edge portions of the discharge cell, so that the aperture ratio of the panel can be increased at the center portion of the discharge cell, and therefore the luminance of a display image can be enhanced.

FIGS. 15 to 18 are sectional views illustrating embodiments of the structure of the upper substrate of the plasma display panel according to the present invention. The same parts as those described with reference to FIG. 1, of the structure of the upper substrate of the panel shown in FIGS. 15 to 18, will not be described for simplicity.

Referring to FIG. 15, a scan electrode 11 and a sustain electrode 12 may be formed on an upper substrate 10 of a panel. A dielectric layer 13 may be stacked on the upper substrate 10.

As described above, the scan electrode 11 and the sustain electrode 12 may have a structure in which a transparent electrode and a bus electrode are stacked or may include only the bus electrode without the transparent electrode. Black matrices, which have a light-shielding function of absorbing external light generated externally and decreasing reflection of the light and a function of enhancing the purity and contrast of the upper substrate 10, may be arranged on the scan electrode 11 and the sustain electrode 12.

A protection layer 14 formed between the dielectric layer 13 and a discharge space may be formed from a material (for example, magnesium oxide (MgO)), which has a large number of secondary emission electrons when ions emitted from the discharge space collide against a surface and has less surface damage due to ion collision.

The discharge efficiency can be enhanced by the secondary emission electrons emitted from the protection layer 14 and therefore a discharge firing voltage can be lowered.

In the case of the plasma display panel according to the present invention, a crystal layer 16 including a material (for example, magnesium oxide (MgO) crystal), which has a large number of secondary emission electrons when ions emitted from the discharge space collide against a surface and has less surface damage due to ion collision, may be formed on the protection layer 14.

When comparing the peak of light emitted when ions emitted from the discharge space collide against a surface, the crystal layer 16 can perform light emission having a peak at a wavelength region lower than that of the protection layer 14.

In other words, the crystal layer 16 emits light having a peak at a wavelength region lower than that of the protection layer 14 when ions emitted from the discharge space collide against a surface, so the discharge efficiency enhanced by the protection layer 14 can be further enhanced.

For example, the crystal layer 16 may include a plurality of magnesium oxide (MgO) crystals having an average diameter of 500 angstrom or more, and the protection layer 14 may consist of MgO particles having a size, which is much smaller than that of the magnesium oxide (MgO) crystals.

A peak of light emitted from the crystal layer 16 when ions emitted from the discharge space collide against a surface may have a wavelength region lower than that of a peak of light emitted from the protection layer 14 according to the size of MgO.

The size of the magnesium oxide (MgO) crystals included in the crystal layer 16 may be decided so that light, which has a peak not overlapped with the peak of light emitted from the protection layer 14 and has a wavelength region lower than that of the light emitted from the protection layer 14, can be emitted from the crystal layer 16.

For example, the peak of light emitted from the crystal layer 16 when ions emitted from the discharge space collide against a surface may have a wavelength region of about 200 nm to 300 nm, and the peak of light emitted from the protection layer 14 may have a wavelength region of about 300 nm to 400 nm, which is a little higher than 200 nm to 300 nm.

As described above, since the protection layer 14 and the crystal layer 16 having different emission peak regions are formed over the upper substrate of the panel, the discharge efficiency can be further enhanced, and a discharge firing voltage can be lowered. Further, delay jitter of address discharge can be reduced by secondary electrons emitted from the two layers 14 and 16.

If the upper substrate of the present invention is constructed as shown in FIG. 15, the discharge efficiency can be enhanced and a discharge firing voltage can be lowered.

As described above, in the event that the scan and sustain electrodes includes only the bus electrodes without the transparent electrodes, a gap between the scan and sustain electrodes can be increased to secure the aperture ratio of the panel, and the increase of a discharge firing voltage generated accordingly are compensated by the construction of the upper substrate of the panel shown in FIG. 15, thereby saving power consumption for panel driving.

Referring to FIG. 16, crystal layers 16a, 16b, and 16c may be divided and formed in some regions over the upper substrate 10. Accordingly, the aperture ratio of the panel can be improved and a reduction in the luminance of a display image can be prevented accordingly.

For example, the crystal layers 16a, 16b, and 16c may be formed at places where they are overlapped with the scan electrode 11 or the sustain electrode 12 in order to further improve the aperture ratio of the panel.

Referring to FIG. 17, a crystal layer 17, including a plurality of magnesium oxide (MgO) crystals, may be overlapped with the scan electrode 11 and the sustain electrode 12, and may be formed on the basis of a gap between the scan electrode 11 and the sustain electrode 12.

Discharge is generated in the gap between the scan electrode 11 and the sustain electrode 12. Thus, if the crystal layer 17 is formed on the basis of the gap between the scan electrode 11 and the sustain electrode 12 as shown in FIG. 17, not only the aperture ratio of the panel can be improved, but also the intensity of light emitted from the crystal layer 17 can be increased.

Referring to FIG. 18, in order to improve the aperture ratio of the panel, crystal layers 18 and 19 including a plurality of magnesium oxide (MgO) crystals may be divided and formed in the scan electrode 11 and the sustain electrode 12, respectively, in such a way to overlap with the scan electrode 11 and the sustain electrode 12, respectively.

In accordance with the plasma display apparatus constructed as described above according to the present invention, manufacturing cost of a plasma display panel can be saved by removing a transparent electrode made from ITO. Further, a discharge firing voltage can be reduced and the luminance of a display image can also be improved by variably adjusting the distance between two electrode lines constituting a scan or sustain electrode.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display apparatus comprising an upper substrate; first and second electrodes formed on the upper substrate; a lower substrate disposed opposite to the upper substrate; and a third electrode formed on the lower substrate, wherein:
at least one of the first and second electrodes is formed as one layer, and comprises first and second electrode lines formed in a direction intersecting the third electrode and a connecting electrode that connects the first and second electrode lines; and
the distance between the first and second electrode lines has a value of 2 or more in one discharge cell.

2. The plasma display apparatus of claim 1, wherein the distance between the first and second electrode lines has different values at central and edge portions of the discharge cell.

3. The plasma display apparatus of claim 1, further comprising a longitudinal barrier rib formed in a direction intersecting the first and second electrodes to define the discharge cell,
wherein the distance between the first and second electrode lines has a maximum value at the central portion of the discharge cell, and decreases as it is adjacent to the longitudinal rib.

4. The plasma display apparatus of claim 3, wherein the maximum value of the distance between the first and second electrode lines is 1.11 to 1.38 of the distance between the first and second electrode lines at a portion overlapping with the longitudinal rib.

5. The plasma display apparatus of claim 1, wherein the maximum value of the distance between the first and second electrodes is 1.05 to 1.4 of the distance between the first and second electrodes at the portion overlapping with the longitudinal rib.

6. The plasma display apparatus of claim 1, further comprising a transverse barrier rib formed in a direction intersecting the third electrode to define the discharge cell,
wherein the first electrode line more adjacent to the center of the discharge cell than the second electrode line has a convex shape in a center direction of the discharge cell.

7. The plasma display apparatus of claim 6, wherein the second electrode line is formed in parallel with the transverse barrier rib.

8. The plasma display apparatus of claim 6, wherein the second electrode line has a convex shape in a direction of the transverse barrier rib.

9. The plasma display apparatus of claim 1, further comprising a longitudinal barrier rib formed in a direction intersecting the first and second electrodes to define the discharge cell,
wherein the distance between the first and second electrode lines has a minimum value at the central portion of the discharge cell, and increases as it is adjacent to the longitudinal rib.

10. The plasma display apparatus of claim 9, wherein the minimum value of the distance between the first and second electrode lines is 0.75 to 0.94 of the distance between the first and second electrode lines at a portion overlapping with the longitudinal rib.

11. The plasma display apparatus of claim 1, further comprising:
a transverse barrier rib formed in a direction intersecting the third electrode to define the discharge cell; and
a first protruding electrode protruded in a direction of the transverse barrier rib from the second electrode line more adjacent to the transverse barrier rib than the first electrode line.

12. The plasma display apparatus of claim 1, further comprising second and third protruding electrodes protruded in the center direction of the discharge cell from the first electrode line more adjacent to the center of the discharge cell than the second electrode line.

13. The plasma display apparatus of claim 12, further comprising adjacent first and second longitudinal barrier ribs formed in a direction intersecting the first and second electrodes on the lower substrate,
wherein the distance between the first and second longitudinal barrier ribs is 1.7 to 3 of the distance between the second and third protruding electrodes.

14. The plasma display apparatus of claim 1, wherein the distance between the first and second electrodes is 1.9 to 3 of the width of the first electrode line.

15. The plasma display apparatus of claim 1, wherein the connecting electrode is not overlapped with the third electrode.

16. The plasma display apparatus of claim 1, further comprising:
a first layer that emits light having a peak at a first wavelength region; and
a second layer that emits light having a peak at a second wavelength region lower than the first wavelength region, the first layer and the second layer being disposed over a dielectric layer of the upper substrate,
wherein the second layer comprises a plurality of magnesium oxide (MgO) crystals.

17. A plasma display apparatus comprising an upper substrate; first and second electrodes formed on the upper substrate; a lower substrate disposed opposite to the upper substrate; and a third electrode formed on the lower substrate, wherein:
at least one of the first and second electrodes is formed as one layer, and comprises first and second electrode lines formed in a direction intersecting the third electrode and a connecting electrode that connects the first and second electrode lines; and
the widths of the first and second electrode lines are different, and the distance between the first and second electrode lines has a value of 2 or more in one discharge cell.

18. The plasma display apparatus of claim 17, wherein the width of the first electrode line more adjacent to the center of the discharge cell than the second electrode line is narrower than that of the second electrode line.

19. The plasma display apparatus of claim 18, wherein the width of the second electrode line is 1.15 to 1.5 of the width of the first electrode line.

20. The plasma display apparatus of claim 17, further comprising a longitudinal barrier rib formed in a direction intersecting the first and second electrodes to define the discharge cell,
wherein the distance between the first and second electrode lines has a maximum value at the central portion of the discharge cell, and decreases as it is adjacent to the longitudinal rib.
